(19) United States
(12) Patent Application Publication
(10) Pub. No.: US 2009/0153860 A1
(43) Pub. Date: Jun. 18, 2009

(54) OPTICAL COMPARATOR USING LIGHT- EMITTING DIODE LIGHT SOURCES

(75) Inventors: Stephanie M. Bloch, Rush, NY (US); Donald Boerschlein, Ontario, NY (US)

Correspondence Address: Stephen B. Salai, Esq.;Harter Secrest & Emery LLP, 1600 Bausch & Lomb Place, Rochester, NY, 14604-2711, US

(73) Assignee: QUALITY VISION INTERNATIONAL, INC., Rochester, NY (US)

(21) Appl. No.: 11/958,079

(22) Filed: Dec. 17, 2007

(51) Int. Cl. G01B 9/08

(52) U.S. Cl. 356/392

(57) ABSTRACT

The invention provides a source of illumination comprising a base having mounted thereon at least one light-emitting diode light source, a parabolic reflector mounted on the base and surrounding the at least one light-emitting diode, and a transmissive diffuser at the narrow end of the parabolic reflector.

### TECHNICAL FIELD

This invention relates generally to illumination sources for optical comparators and more particularly to illumination sources using light-emitting diodes that can be used in optical comparators in place of incandescent or halogen sources without substantial modification of the comparators.

### BACKGROUND OF THE INVENTION

Optical comparators are known for use in assessing the quality of manufactured parts or other objects. Optical comparators typically use one or more of three illumination sources, (a) a backlight source for profile illumination, (b) a brightfield source for co-axial surface illumination, and (c) a darkfield source for oblique surface illumination. Each of these sources has somewhat different requirements, but heretofore, each source was typically constructed using an incandescent light source, more commonly a halogen light source and reflector. Reflector-type halogen bulbs are quite commonly used in projectors of various sorts and consequently are widely available at reasonable prices. However, while such bulbs produce substantial amounts of light, they are inefficient, have a relatively short life, generate substantial heat, and require regular maintenance that can add significantly to the cost of such bulbs.

Furthermore, because halogen bulbs are relatively inefficient, bulbs that generate sufficient light for use in comparators also generate a considerable amount of heat, which can affect an object under test due to thermal expansion.

Furthermore, at least the backlight (profile illumination) source used in an optical comparator is preferably green. Halogen light sources are generally speaking broad-spectrum, white-light sources, and it is necessary to filter the halogen light source to produce the desired green illumination. Such filtering reduces the efficiency of the light source still further, usually by a significant amount.

The brightfield (coaxial surface illumination) and darkfield (oblique surface illumination) light sources in a comparator are often broad-spectrum or white-light sources and typically require somewhat more power than the backlight (profile illumination) source due to the low reflection off the typical surface under test. Nevertheless, the inefficiencies of halogen light sources produce similar disadvantages when used for the brightfield (coaxial surface illumination) and darkfield (oblique surface illumination) light sources in an optical comparator. The brightfield (coaxial surface illumination) source must generally be significantly brighter than the darkfield (oblique surface illumination) source to reveal surface features because reflection efficiency decreases with decreasing angles of incidence.

There is a need for light sources for optical comparators that overcome the problems mentioned above. To be suitable for use in an optical comparator, a light source must be bright, have high efficiency, produce as little heat as possible, and, depending on whether the light source is used for the profile, coaxial surface, or oblique surface illumination, must produce an appropriate amount of light.

More specifically, the light used for the backlight (profile illumination) source preferably provides a relatively large uniformly illuminated area that is collimated to illuminate the peripheral features of the article. The backlight (profile illumination) source may require one or more diffusers, one at the focal plane of a collimating lens, and one between the object under test and the collimating lens. The backlight (profile illumination) source may also include a reflector.

Recently, light-emitting diodes have become available that produce a greater light output than has been available from such diodes in the past. However, heretofore, light-emitting diodes have not been employed as illuminators for optical comparators for a variety of reasons. High-powered light-emitting diodes are typically provided on printed circuit boards, which are not readily useable as plug-in substitutes for halogen light sources. If placed in a conventional reflector arrangement, the printed circuit boards on which the light-emitting diodes are mounted block a substantial amount of light. The light-emitting diodes produce a white-light beam that is somewhat unidirectional, though often having a relatively broad beam width, which is substantially different from and not compatible with the beams produced by halogen light bulbs. Typically, light-emitting diodes, while more efficient than halogen light sources, still require mounting on a substantial heat sink to conduct heat away from the light-emitting diode elements.

### SUMMARY OF THE INVENTION

This invention among its preferred embodiments provides a light source adaptable to replace two of the three illumination sources currently used in optical comparators, the brightfield coaxial surface illumination source and the backlight profile illumination source. For the purposes of the brightfield coaxial surface illumination and the backlight profile illumination, the sources in accordance with this invention can include one or more light-emitting diodes (LEDs) mounted off axis on a base, a tapered reflector surrounding the light-emitting diodes and having its wide end disposed adjacent to the base and its narrow end open and remote therefrom, and a transmissive diffuser, which can also include a color filter mounted adjacent the open end of the tapered reflector. The darkfield oblique surface illumination source is also preferably formed from light-emitting diodes and comprises two or more light-emitting diodes surrounding a front lens with a focusing lens for each of the diodes directing the light from the diodes onto the surface of a test object at a non-normal angle of incidence.

Preferably, the tapered reflector used in the brightfield coaxial surface illumination and backlight profile illumination sources comprises the frustum of a parabolic reflector. More preferably, the tapered reflector comprises the frustum of a parabolic reflector cut off on a plane further from the closed end of the parabola than the plane in which the focus of the parabola lies.

Preferably, the light-emitting diodes are mounted on a diffuse reflective base disposed at the wide end of the parabolic reflector. The light-emitting diodes are preferably mounted off center on the base, away from the optical centerline or axis of the tapered reflector. In the case where more light is needed, an additional light-emitting diode can be mounted on axis.

In accordance with this invention, the backlight profile illumination source and the brightfield coaxial surface illumination source differ only slightly. The backlight source can be constructed using green-light LED's or using white-light LED's together with a green filter mounted at the narrow end of the tapered reflector whereas the brightfield source preferably has no color filter. The backlight and brightfield illumination systems for conveying light to the test object are distinguished in that the backlight illumination system preferably has an extra diffuser at a far side of a collimating lens, whereas the brightfield illumination system preferably includes a relay lens system for conveying an image of the diffuser.

### BRIEF DESCRIPTION OF THE DRAWING FIGURES

FIG. 1 is a perspective view of a comparator having multiple light sources in accordance with this invention.

FIG. 2 is a cross-sectional view through a portion of a base of the comparator of FIG. 1 showing an illumination source within the base.

FIG. 3 is a perspective front view of an illumination source in accordance with the invention.

FIG. 4 is a perspective back view of the illumination source.

FIG. 5 is a side view of the illumination source.

FIG. 6 is a top plan view of the illumination source with a diffuser/filter removed.

FIG. 7 is an enlarged back view of the illumination source.

FIG. 8 is a similarly enlarged cross-sectional side view of the illumination source taken along line A-A of FIG. 8.

FIG. 9 is a diagrammatic view of the optical components of a comparator of the type shown in FIG. 1 showing two illumination sources in accordance with this invention.

### DETAILED DESCRIPTION OF THE INVENTION

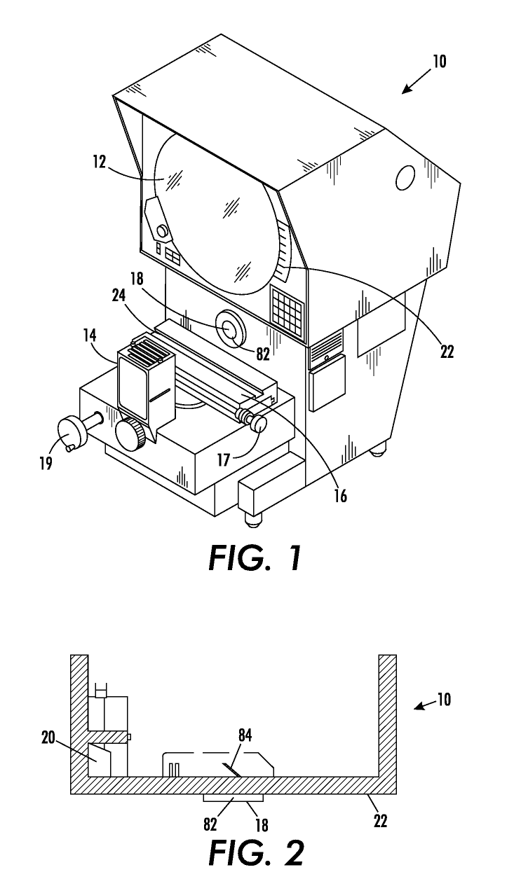

Referring now to FIG. 1, a comparator of the type with which the light sources of this invention can be used is illustrated in a diagrammatic, perspective view. The comparator indicated generally at 10 includes a precision stage 16 on which a test object (not shown) under inspection can be mounted. Various manual controls 17 and 19 adjust the position of the stage 16, which can also include motors, actuators, or the like for automatically positioning and/or moving the test object under inspection.

The comparator 10 includes a display screen 12 on which an image of the test object can be formed from a combination of light from different sources. The display screen 12 can be provided with various reticles or overlays by which the test object can be evaluated as to its size, shape, internal dimensions, or the like. Typically, rotary encoders and the like are associated with the screen overlays. The stage 16, which is used to hold and move the test object, can also include a jig or other support attached to the stage 16 for gripping the test object. The stage 16 is typically equipped with graduated X-Y linear encoders.

The comparator 10 includes multiple light sources. Backlight source 14 illuminates a back side of the test object for measuring the test object profile, a brightfield source 20, which can be seen in FIG. 2 mounted within a base 22 the comparator 10, coaxially illuminates a front surface of the test object with a light beam emanating from opening 18, and a darkfield source (not shown) also preferably disposed within the comparator 10 obliquely illuminates the front surface of the test object through the opening 18.

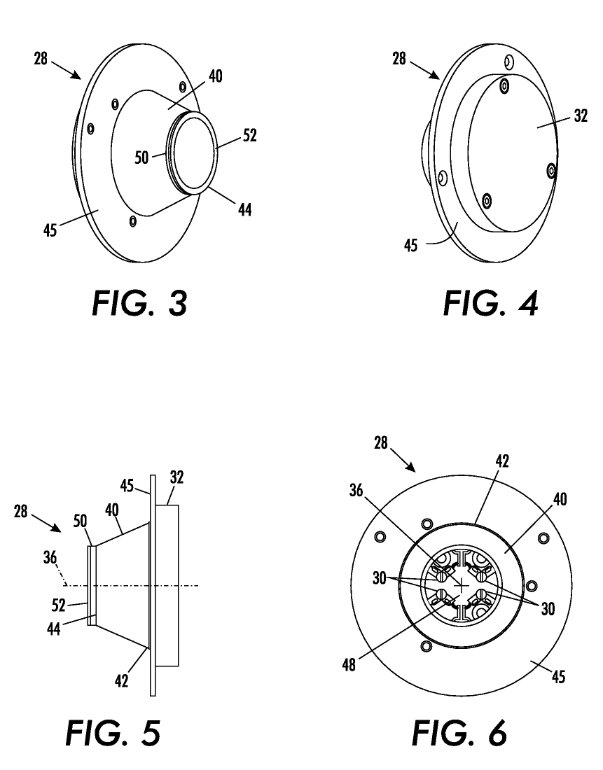

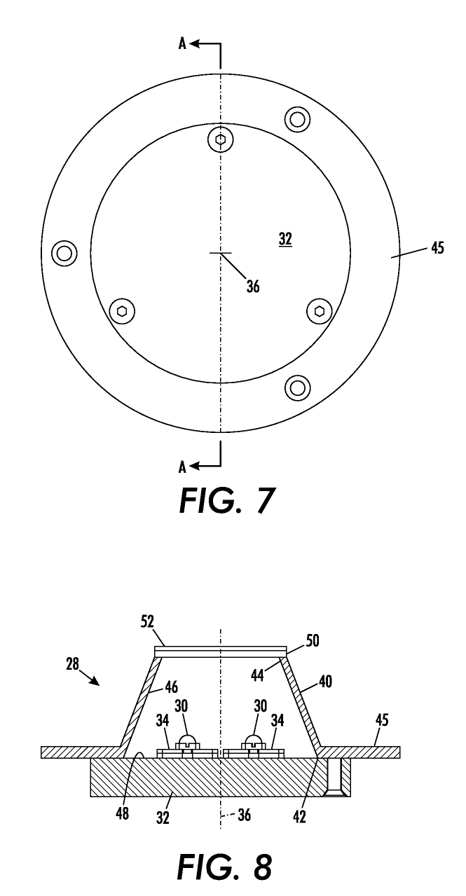

Referring to FIGS. 3-8, a light source 28 particularly adapted as a backlight source for providing the profile-illuminating function is illustrated in more detail. The light source 28 includes one or more light-emitting diodes 30 mounted on a heat sink 32. While the light-emitting diodes 30 are shown mounted to printed circuit boards 34 of the type on which such light-emitting diodes 30 are commonly supplied, the printed circuit boards 34 per se are not an essential part of the invention. It is preferred that the light-emitting diodes 30 be mounted off axis, that is, spaced from an optical axis 36 running through the center of the illumination source. If more light is needed, an additional light-emitting diode (not shown) can be placed on axis to provide the additional light.

An inverted conical reflector 40 is mounted to one surface of the heat sink 36. The conical reflector 40 has its wide end 42 abutting the heat sink 32 and its narrow open end 44 distal therefrom. A flange 45 at the wide end 42 of the conical reflector 40 provides for mounting the conical reflector to both the heat sink 32 and a frame (not shown) of the optical comparator 10. The conical reflector 40 is preferably provided with a highly reflective coating on its inside surface 46, or in the alterative is made from a highly reflective material, the inside surface 46 of which faces the light-emitting diodes 30. A transmissive diffuser 50 or alternatively, a combination diffuser and color filter is attached to the narrower end 44 of the conical reflector 40.

The conical reflector 40 of this invention tapers inwardly from the wide end 42 that is attached to the heat sink 32 to the narrow end 44 where the diffuser 50 is mounted. The precise shape of the conical reflector 40 can vary in accordance with this invention. For example, a parabolic shape can be used, and in this form, the conical reflector 40 preferably comprises the frustum of a parabola having the narrow end 44 cut at a point so that the focus of the parabola lies outside of the volume bounded by the two ends 42 and 44 of the conical reflector 40. This has been found to provide bright, relatively uniform illumination of the diffuser 50, which acts as a separate uniform light source that is imaged by other optics of the comparator 10 as will be described in more detail below. The height and inclination of the reflective surface 46 of the conical reflector 40 are selected experimentally to maximize both the amount and the uniformity of light falling on the diffuser 50. A surface 48 of the heat sink 32 on which the light-emitting diodes 30 are mounted can be formed with a specular or a diffuse reflective surface to further illuminate the diffuser 50.

Oftentimes, comparator users prefer that the backlight profile illuminator source 30 produces green light. In accordance with this invention, the light-emitting diodes 30 that produce white light can be used in combination with a green filter 52 or alternatively, light-emitting diodes that produce green light can be used with the diffuser 50 and no color filter.

In accordance with this invention, the brightfield coaxial surface illuminator source 20 for use in the comparator 10 also has a construction substantially similar to that of the light source 28 shown in FIGS. 3-8 but the light output is preferably white light and the illuminator uses the white-light light-emitting diodes 30 with the diffuser 50 and no color filter 52. It is preferred in accordance with this invention that the various illumination sources (e.g., backlight source 14 and brightfield source 20) for the comparator 10 are as similar as possible in order to reduce the costs thereof by exploiting manufacturing economies. Consequently, it may be desirable to construct the backlight profile illuminator source 14 with the white-light light-emitting diodes 30 and the filter 52 as shown, rather than with a green-light light-emitting diodes and no filter 52, so that the backlight profile and brightfield coaxial surface illuminator sources 14 and 20 can be constructed similarly.

The darkfield oblique surface illuminator (not shown) for use in a comparator 10 of the type shown in FIG. 1 can be provided by direct illumination with white-light light-emitting diodes each having an associated lens directing light onto the stage 16 or the test object under illumination without the need for the conical reflector 40 or any filter 52.

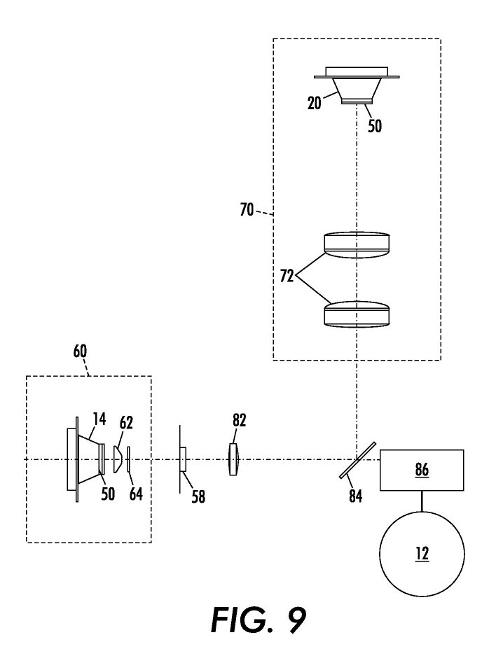

FIG. 9 is an optical schematic diagram showing the relationship among the light sources 14 and 20, the test object now referenced by number 58, and other optical components of the comparator 10. The light sources 14 and 20 participate as parts of two illumination systems, the backlight source 14 supplying light to a profile illumination system 60 (outlined in dashed lines) and the brightfield source 20 supplying light to a coaxial surface illumination system 70 (also outlined in dashed lines).

As discussed, the backlight profile illuminator 60 utilizes the light-emitting diodes 30 and the inverted conical reflector 40 to illuminate the diffuser 50 uniformly. A collimating lens 62, images the diffuser 50 at infinity. A second diffuser 64 is placed after the collimating lens 62 to diffuse the image of the diffuser 50, which would otherwise be apparent on the screen 12. Light representing the profile of the test object 58 is imaged on the display screen 12 by way of lens 82 and beamsplitter 84, and magnifying optics 86.

The brightfield coaxial surface illuminator 70, which includes a similar white-light source, is imaged by a relay system 72 comprising two doublets and reflected by the beamsplitter 84, onto the front lens 82. The light passes through front lens 82 and impinges on a front surface of the test object 58 under inspection. Light reflected from the front surface of the test object 58 passes through lens 82, the beamsplitter 84, and the magnifying optics 86 to display screen 12.

Finally, the darkfield oblique surface illuminator (not shown) projects light directly on the front surface of the test object 58 at non-normal angles of incidence. Light reflected from the front surface of the test object 58 takes a similar route to the test screen 12, via the front lens 82, the beamsplitter 84, and the magnifying optics 84 so that the test object 58 is similarly imaged despite being illuminated in different ways.

Although described with respect to preferred embodiments, the embodiments can be modified in accordance with its teaching to accommodate or adapt to particular applications or purposes. For example, the preferred embodiments feature conventional light-emitting diodes for producing white or green light. However, other solid-state illumination sources such as organic light-emitting diodes (OLED) or polymer light-emitting diodes (PLED), could also be used depending on the requirements for nominal wavelength, bandwidth, and intensity.

1. An optical comparator comprising:
a display screen;
a stage for holding and moving an object
a light source including one or more solid state illumination sources; a diffuser disposed between the solid state illumination sources and the stage, and an inverted, truncated, generally-conical reflector surrounding the illumination sources and having the diffuser disposed at its narrow end.
optics disposed between the stage and the display for imaging the object on the screen.

2. The optical comparator of claim 1 in which the reflector comprises an inverted parabolic reflector.

3. The optical comparator of claim 1 in which the illumination sources comprise light-emitting diodes.

4. The optical comparator of claim 1 in which the illumination sources comprise white-light light-emitting diodes.

5. The optical comparator of claim 1 also comprising a color filter disposed optically adjacent to the diffuser.

6. The optical comparator of claim 5 in which the color filter is a filter for passing green light.

7. The optical comparator of claim 1 in which the optics disposed between the stage and the display comprises a relay lens.

8. The optical comparator of claim 1 in which the illumination sources are mounted on a reflective base.

9. The illumination source of claim 8 in which the reflective base comprises a diffuse reflective base.

10. The optical comparator of claim 1 further comprising a brightfield illuminator comprising one or more solid state illumination sources; a second diffuser disposed between the solid state illumination sources and the object, and a second inverted, truncated, generally-conical reflector surrounding the illumination sources and having the diffuser disposed at its narrow end.

11. The optical comparator of claim 10 further comprising a collimation lens disposed between the diffuser and the object.

12. A source of illumination comprising a base having mounted thereon at least one light-emitting diode light source, a parabolic reflector mounted on the base, and surrounding the at least one light-emitting diode, and a diffuser closing the narrow end of the parabolic reflector.

13. The light source of claim 12 wherein said at least one light-emitting diode light source comprises at least one white-light light-emitting light-emitting diode.

14. The light source of claim 12 wherein the parabolic reflector has an inner reflective coating of nickel or aluminum.

15. The light source of claim 12 wherein said at least one light in many diode light source comprises at least one green color emitting light-emitting diode.

16. The light source of claim 12 wherein said diffuser emits 90% of the light from the at least one light-emitting diode.

17. The light source of claim 12 wherein the diffuser is also a green filter.

18. The light source of claim 12 wherein at least one light-emitting diode comprises four light-emitting diodes.

19. The light source of claim 12 wherein the parabolic reflectors is reflective inside coating.

20. A comparator comprising at least one source of illumination comprising a base having mounted thereon at least one light-emitting diode light source, a parabolic reflector mounted on the base, and surrounding the at least one light-emitting diode, and a diffuser closing the narrow end of the parabolic reflector.

21. A comparator of claim 20 wherein said comparator comprises two light sources.

22. The comparator of claim 21 wherein one light source is behind the object to be projected.

23. The comparator of claim 22 wherein the light source behind the object is provided with a green filter.

24. The comparator of claim 20 wherein the illumination light source for said comparator comprises white-light light-emitting diodes.

25. The comparator of claim 24 wherein the light from the light source is passed through a collimation lens focused on the diffuser of said light source.

26. The comparator of claim 20 wherein said comparator comprises a collimating lens imaging the diffuser light Into infinity.
